(19) United States
(12) Patent Application Publication
(10) Pub. No.: US 2025/0293420 A1
(43) Pub. Date: Sep. 18, 2025

(54) WAVEGUIDE ASSEMBLY

(71) Applicants: Huawei Technologies Canada Co., Ltd., Kanata (CA); la corporation de I' École Polytechnique de Montréal, Montréal (CA)

(72) Inventors: Chunmei Liu, Montreal (CA); Ke Wu, Saint-Laurent (CA)

(21) Appl. No.: 19/224,242

(22) Filed: May 30, 2025

Related U.S. Application Data
(63) Continuation of application No. PCT/CA2022/051770, filed on Dec. 2, 2022.

(51) Int. Cl. H01P 3/16; H01P 1/02; H01P 5/12; H01P 11/00

(52) U.S. Cl. CPC H01P 3/16; H01P 1/022; H01P 5/12; H01P 11/006

(57) ABSTRACT

Aspects of the present disclosure provide a waveguide assembly that employs a non-radiative dielectric waveguide at a bend and a dielectric waveguide away from the bend. By implementing a non-radiative dielectric wave guide at the bend and a dielectric waveguide away from the bend the power dissipated during propagation can be minimized without necessitating an increase in the size of the system. A method of manufacture of the waveguide assembly is also provided.

### CROSS-REFERENCE TO RELATED APPLICATIONS

The present application is a continuation of Patent Cooperation Treaty Application Serial No. PCT/CA2022/051770, entitled “A WAVEGUIDE ASSEMBLY,” filed on Dec. 2, 2022, the entirety of which is incorporated by reference herein.

### TECHNICAL FIELD

The present application relates to waveguides and, in particular, to a waveguide assembly forming a hybrid waveguide.

### BACKGROUND

The functional parts of wireless systems, such as communication and/or sensing systems, are typically interconnected and built up by waveguides. Waveguides may be used to transfer energy and signals between modules in an integrated system. Within each module, waveguides may be used to transfer energy and signals between components, which are also constructed by waveguide parts. Waveguides may thus be considered to be the basic building element that underpins wireless systems. To achieve a high channel capacity needed in wireless systems, either the input power needs to be increased to obtain an acceptable signal to noise ratio (SNR) or waveguides need to operate over a wide bandwidth with minimal losses. In some bands, such as the Terahertz (THz) band, it may be difficult to increase the source power. In addition, the performance of active components in the THz might not be reliable or not always be satisfactory, which means that reducing the power that is dissipated during propagation is likely to be most effective and feasible way to improve the performance of integrated systems in the THz band. In addition, loss-reduced high-quality passive components and system integration are highly desirable for the enhancement of system performance.

There are various sources of transmission loss. Structural loss may be reduced by optimizing the waveguide geometry, as demonstrated in the ribbon waveguide. In optical applications, photonic bandgap (PBG) crystals have been widely used to guide energy and signal in a specific direction based on Bragg reflection. PBG structures have also been applied to microwave and THz band to confine the transmission of electromagnetic waves. By periodically distributing different materials with a certain pattern, 90° bend or even sharper bend may be achieved. However, achieving a fine periodic structure requires a high-performance fabrication facility, which increases design complexity, particular for the THz band. Alternatively, transmission losses may be reduced by increasing the size or curvature of any bends in the system. However, this can result in an increase in system size. Therefore, transmission losses at bends remains an outstanding problem.

### SUMMARY

By reducing the power and signal loss during transmission between components of a wireless system, the high channel capacity needed for current and future wireless systems may be achieved without necessitating an increase in source power. Power loss during transmission may be decreased by using low-loss waveguides. Although metallic waveguides exhibit low transmission loss, they may not be suitable for many integrated systems due to their bulky and heavy mechanical structure. Planar waveguides, which are not fully metal-based structures, are one alternative. However, planar waveguides can exhibit energy leakage including signal loss at bends and junctions. Integrated systems typically involve many bends for redirecting wave transmission (e.g. at junctions such as dividers, couplers, crossovers etc.). The energy leakage of planar waveguides may be reduced by designing a system to have smoother bends with a larger radius of curvature. However, this increases the size of the system and may also increase path length, which can further increase transmission loss.

Aspects of the present disclosure provide a waveguide assembly that employs a non-radiative dielectric waveguide at a bend and a dielectric waveguide away from the bend. In both the dielectric waveguide and the non-radiative dielectric waveguide, the contrast in the relative permittivity between a dielectric core and surrounding overlays confines the wave to the dielectric core. In the non-radiative dielectric waveguide, the dielectric core is sandwiched between two parallel conductive plates, which is set to reduce the radiative losses at the bend, even for sharp or tight bends. However, away from bends, non-radiative dielectric waveguides can exhibit higher losses than dielectric waveguides due to the presence of the conductive plate (e.g. leading to metallic losses) and its more confined field pattern within the dielectric core. Therefore, implementing a non-radiative dielectric waveguide at the bend and a dielectric waveguide away from the bend minimises the power dissipated during transmission without necessitating an increase in the size of the system.

In one aspect, a waveguide assembly is provided. The waveguide assembly includes a first non-radiative dielectric waveguide and a first dielectric waveguide. The first non-radiative dielectric waveguide includes a first pair of parallel conductive plates and a first bent dielectric strip disposed between the first pair of parallel conductive plates. The first bent dielectric strip includes a first bend. The first dielectric waveguide includes a first exposed dielectric strip. The first non-radiative dielectric waveguide is connected to an end of the first dielectric waveguide to form a first transmission path for an electromagnetic wave through the first dielectric waveguide and the first non-radiative dielectric waveguide.

The first exposed dielectric strip may be straight. Alternatively, the first exposed dielectric strip may include a second bend having a larger radius than the first bend.

The first bent dielectric strip and the first exposed dielectric strip may be integrally formed.

The waveguide assembly may also include a second dielectric waveguide. The second dielectric waveguide may include a second exposed dielectric strip. The second dielectric waveguide may be connected to the first non-radiative dielectric waveguide such that the first non-radiative dielectric waveguide is between the first dielectric waveguide and the second dielectric waveguide.

The second exposed dielectric strip may be straight. Alternatively, the second exposed dielectric strip may have a third bend having a larger radius than the first bend.

The second exposed dielectric strip may be integrally formed with the first bent dielectric strip.

The electromagnetic wave may include a Terahertz wave such that the waveguide assembly is configured to receive the Terahertz wave for propagation along the first transmission path.

The first non-radiative dielectric waveguide may be connected to the end of the first dielectric waveguide to form a first branch of the waveguide assembly. The waveguide assembly may also include a second non-radiative dielectric waveguide. The second non-radiative dielectric wave guide may include a second pair of parallel conductive plates and a second bent dielectric strip disposed between the second pair of parallel conductive plates. The second non-radiative dielectric waveguide may be connected to the end of the first dielectric waveguide to form a second branch of the waveguide assembly. The second branch of the waveguide assembly may form a second transmission path through the first dielectric waveguide and the second non-radiative dielectric waveguide.

The waveguide assembly may include a waveguide divider.

The waveguide assembly may include a waveguide combiner.

The first pair of parallel conductive plates and the second pair of parallel plates may be the same. Alternatively, the first pair of parallel conductive plates may be separate to the second pair of parallel plates.

The electromagnetic wave may include a Terahertz wave such that the waveguide assembly is configured to receive the Terahertz wave for propagation along the first transmission path or the second transmission path.

In another aspect, a method of manufacturing a waveguide assembly is provided. The method involves obtaining a strip of dielectric material, in which the strip includes a bent section of the dielectric material, and disposing the bent section of the strip between a pair of parallel conductive plates to cover two opposing sides of the bent section by the pair of parallel conductive plates to form a non-radiative dielectric waveguide. A remaining section of the strip is left exposed to form another waveguide connected to the non-radiative dielectric waveguide.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 shows the cross-sections of examples of six different types of waveguides.

FIG. 6, which shows the losses of a dielectric waveguide and a non-radiative dielectric waveguide at frequencies between 240 and 330 GHz.

FIG. 7 which shows the field distribution of two dielectric waveguides.

FIG. 8 shows a waveguide assembly according to an embodiment of the disclosure.

FIG. 9 shows another waveguide assembly according to another embodiment of the disclosure.

FIGS. 10 and 11 show the transverse electric field patterns of the E₁₁^{x} mode of a dielectric waveguide and an LSMₒ₁^{x} mode of a non-radiative dielectric waveguide according to embodiments of the disclosure.

FIGS. 12 and 13 show the dispersion curves of test waveguides according to embodiments of the disclosure.

FIG. 14 shows the transmission and reflection of a waveguide assembly according to an embodiment of the disclosure.

FIG. 15 shows the transmission and reflection of a waveguide assembly according to another embodiment of the disclosure.

FIGS. 16 and 17 show the field distribution over a bending area of a waveguide in the absence and presence of metal plates.

FIG. 18 shows a dielectric structure according to an embodiment of the disclosure.

FIG. 19 shows a bent dielectric strip of the dielectric structure according to the embodiment of the disclosure.

FIG. 20 shows a metallic housing according to the embodiment of the disclosure.

FIG. 21 shows the simulated and measured transmission and reflection of the fabricated waveguide assembly according to the embodiment of the disclosure.

FIG. 22 shows the transmission and reflection of the fabricated waveguide assembly with and without the metallic housing.

FIG. 23 shows a waveguide assembly according to embodiments of the disclosure.

FIG. 24 shows a non-radiative dielectric waveguide according to embodiments of the disclosure.

FIG. 25 shows a flowchart of a method according to an embodiment of the disclosure.

### DETAILED DESCRIPTION OF ILLUSTRATIVE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

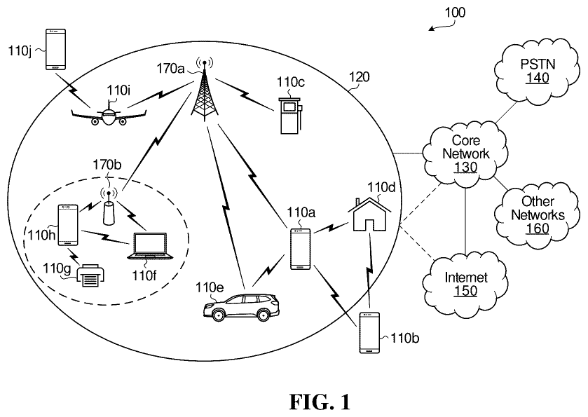

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

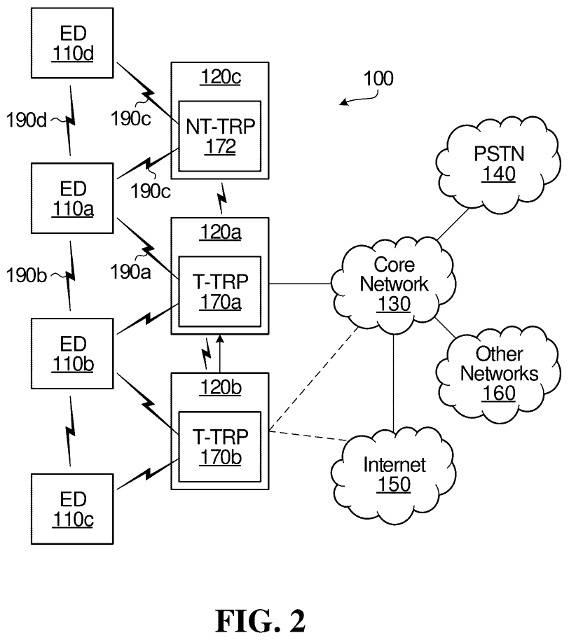

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

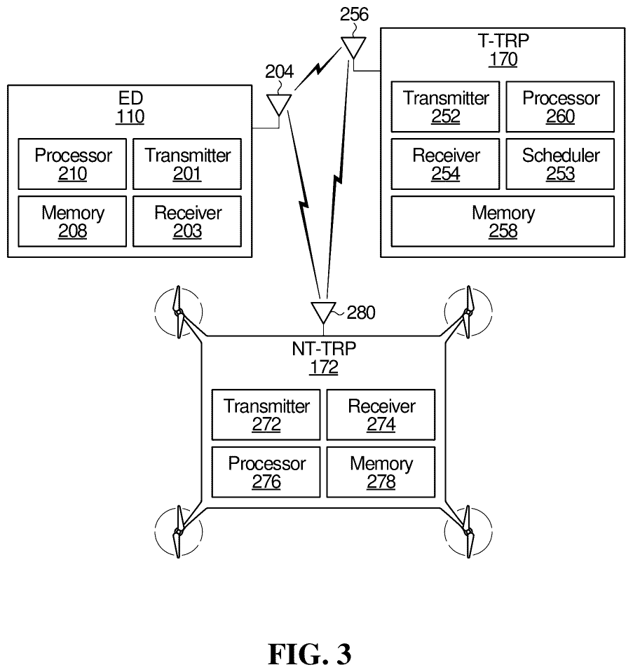

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

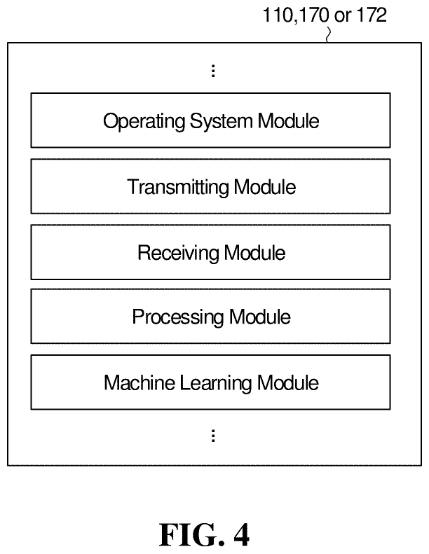

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Waveguides

Waveguides may be used to transfer energy, in the form of electromagnetic waves or radiation, between components of a system. For example, a receiver, such as any of the receivers 203, 254, 274 described above, may include components interconnected by waveguides, in which the components include one or more of: an antenna, a low noise amplifier (LNA), a filter, a mixer etc. As another example, the components of a transmitter, such as any of the transmitters 201, 252, 272, that are interconnected by waveguides may include one or more of: an antenna, a power amplifier, a filter, a mixer, a modulator, etc. A transceiver may include a combination of these components.

Terahertz frequencies (e.g. 0.1-10 THz) are being proposed as a possibility for wireless communications and sensing systems. Development of Terahertz technologies is ongoing, with manufacturing difficulties resulting in many active components suffering from poor performance, such as high insertion loss. Reducing the losses during propagation of Terahertz radiation through waveguides is proposed as an effective and feasible way to improve the performance of Terahertz systems.

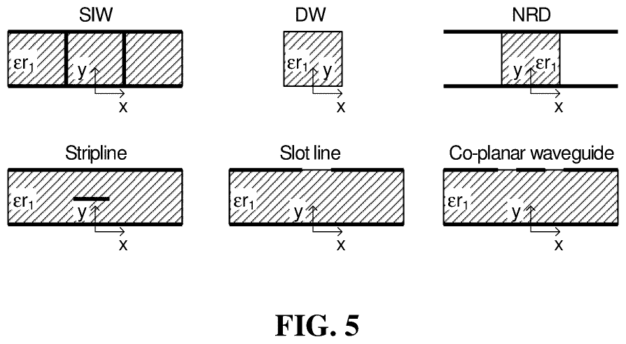

The loss mechanisms of a waveguide depend on geometry, the frequency of the electromagnetic waves travelling through the waveguide and the propagation mode. FIG. 5 shows the cross-sections of examples of six different types of waveguides: a substrate integrated waveguide (SIW), dielectric waveguide (DW), a non-radiative dielectric waveguide (NRD or NRDW), a stripline waveguide, a slot line waveguide and a co-planar waveguide.

Each of the waveguides shown in FIG. 5 include a strip (e.g. a length, slab, rod or sheet) of dielectric material with permittivity εr₁. These waveguides may be referred to as planar waveguides since they guide electromagnetic waves in one dimension, which may be referred to as the transmission dimension. For the waveguides shown in FIG. 5, the transmission dimension is perpendicular to the x and y dimensions (e.g. extends out of or into the page).

The simplest of the waveguides shown in FIG. 5 is the dielectric waveguide (DW). In the dielectric waveguide shown in FIG. 5, the strip of dielectric material is exposed to the air on all sides. The strip of dielectric material forms a dielectric core through which electromagnetic waves, such as radio waves or THz waves, can propagate. The change in permittivity from at the surface of the strip of dielectric material confines the electromagnetic waves to the strip. Although the example dielectric wave shown in FIG. 5 is exposed to air on all sides, it will be appreciated that, in general, the dielectric core of a dielectric waveguide may be exposed to another dielectric substance (e.g. another dielectric material) with permittivity εr₂<εr₁. Air is just one example of the other dielectric substance that may be used. Although dielectric waveguides have mostly been used in photonic circuits, they exhibit a great potential in the development of THz circuits due to the at least partial absence of metallic loss.

In contrast to the dielectric waveguide, the strip of dielectric material in each of the substrate integrated waveguide, stripline waveguide, slot line waveguide and co-planar waveguide is held between two conducting plates. Each plate extends to, but not beyond, the edge of the dielectric material.

The substrate integrated waveguide also includes two parallel rows of via holes, in which each via hole extends from one plate to the other. Since FIG. 5 shows a cross-section of the substrate integrated waveguide, the via holes are shown as black strips extending vertically between the bottom plate (shown by a lower horizontal black line) and the top plate (shown by an upper horizontal black line). The stripline waveguide also includes a conducting strip embedded in the strip of dielectric material. In the example shown in FIG. 5, the conducting strip is illustrated as being in the centre of the dielectric material. In other examples of stripline waveguides, the conducting strip may be offset from the centre of the dielectric material. Due to the development of laser drilling techniques and metallized via techniques, substrate integrated waveguides, which work as a planar form of a metallic waveguide, are considered to have potential for integrated systems.

In the slot line waveguide, one of the conducting plates has a slot running along its length (e.g. the slot is elongated along the transmission path through the waveguide). The co-planar waveguide is similar to the slot line waveguide, but with slots running along the length of one of the conducting plates (e.g. both slots are elongated along the transmission path through the waveguide).

In the non-radiative dielectric waveguide, the strip of dielectric material is held between two conducting plates. However, the two conducting plates extend beyond the edge of the strip of dielectric material leaving an air gap between the two conducting plates. The electromagnetic field is confined in the dielectric strip because of the large contrast in permittivity between the dielectric strip and air. In general, the air may be any dielectric material that has a permittivity εr₂ that is less than the permittivity of the material forming the dielectric strip (e.g. εr₂<εr₁). Air is just one example of the other dielectric material that may be used. As a result of the structure of the non-radiative waveguide, the electromagnetic wave field decays exponentially outside the dielectric strip, which means that propagation of electromagnetic waves outside the dielectric core is prevented.

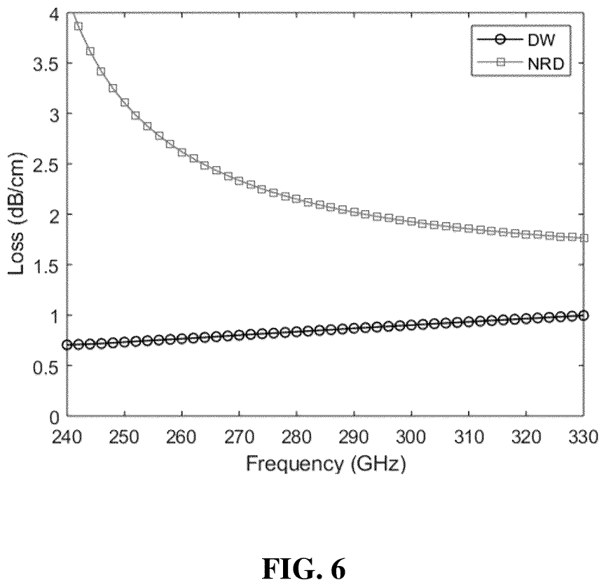

As the stripline, slot line, substrate integrated, non-radiative dielectric, and co-planar waveguides include conductive plates, electromagnetic waves propagating through these types of waveguides experience conductor, or metallic, losses. As the dielectric waveguide does not include conductive plates, it does not experience conductor losses. This may be illustrated with reference to FIG. 6, which shows the losses of a dielectric waveguide (DW; circles) and a non-radiative dielectric waveguide (NRD; squares) at frequencies between 240 and 330 GHz. At all frequencies shown, the non-radiative dielectric waveguide experiences greater losses due to conductor losses.

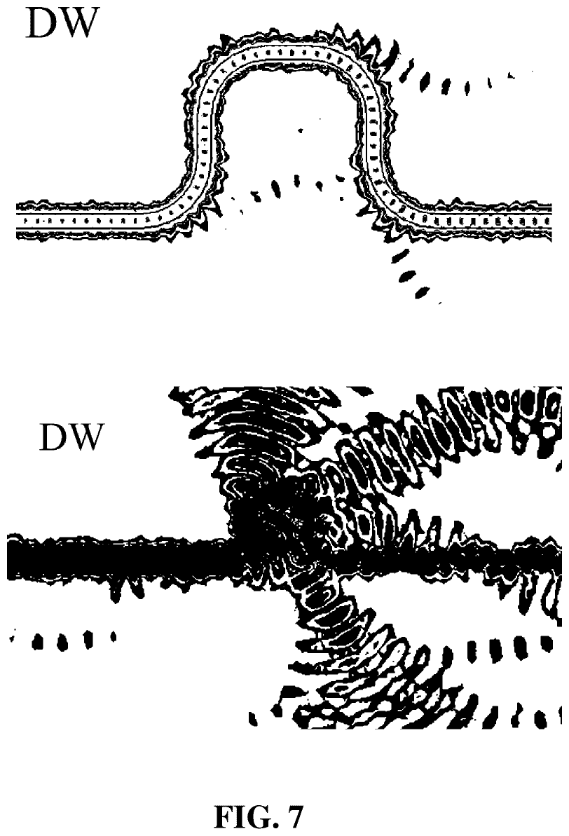

However, dielectric waveguides can experience significant radiation leakage at bends. This may be illustrated by reference to FIG. 7 which shows the field distribution of two dielectric waveguides. Both waveguides include bends, but the bends in the waveguide in the top image have a larger radius of curvature (e.g. the waveguide in the bottom image has sharper bends). Due to its larger, smoother bends, the waveguide in the top image shows only limited radiation leakage. However, the waveguide in the bottom image, with sharp bends, shows significant radiation leakage at the bends.

As a result of the potential for energy leakage at bends, the implementation of dielectric waveguides in highly integrated systems has been limited. Waveguide bends are often a fundamental building block in wireless systems for constructing functional components such as dividers, couplers and circulators. Although this can be partially mitigated by increasing the curvature of a bend and applying an additional polymer coating, bends with a large curvature may not be suitable for highly integrated systems. In addition, increase the curvature of a bend may increase the path length and thereby lead to a higher propagation loss.

Further challenges still remain for waveguides in the THz band. Different types of metallic waveguides, such as metallic waveguides with or without an inner coating, have been developed for the THz band. Planar waveguides, such as a microstrip line, a co-planar waveguide, and a substrate integrated waveguide, may not be practical in THz band circuits and antennas because their finite conductivity and potential field singularity may cause high frequency-dependent conductor losses. In addition, the fabrication process for waveguides may affect the roughness of conductor surfaces in these waveguides, which can increase conductor losses in the THz band. Moreover, the open structure of waveguides such as the co-planar wave guide and microstrip line can trigger additional problems such as energy leakage at discontinuities. Energy leakage and signal loss can be reduced by implementing smoother bends with a large curvature. However, this causes a corresponding increase in the dimension of circuits incorporating these waveguides. The radius of curvature of a bend may thus be constrained by system size (e.g. compactness) and electromagnetic compatibility. Existing measures for suppressing crosstalk between channels may also face additional challenges in the THz band. One such measure is the implementation of a metallized via fence to reduce mutual coupling between adjacent channels. However, it is difficult to manufacture a metallized via that is suitable for a THz waveguide because the roughness metallized via holes can introduce additional losses in the THz band.

### Waveguide Assembly

According to aspects of the present disclosure, a non-radiative dielectric waveguide may be implemented at a bent section in order to minimize radiative losses, whilst a dielectric waveguide may be implemented in a straighter section (e.g. in a straight section or at a smoother bend) to minimize conductor losses. This results in a hybrid waveguide assembly that includes a non-radiative dielectric waveguide at a bend and a dielectric waveguide elsewhere. Since propagation losses are a key issue in THz systems and dielectric waveguides perform well in the THz band, this hybrid waveguide assembly may be particularly advantageous for the development of low loss, highly integrated THz circuits and systems.

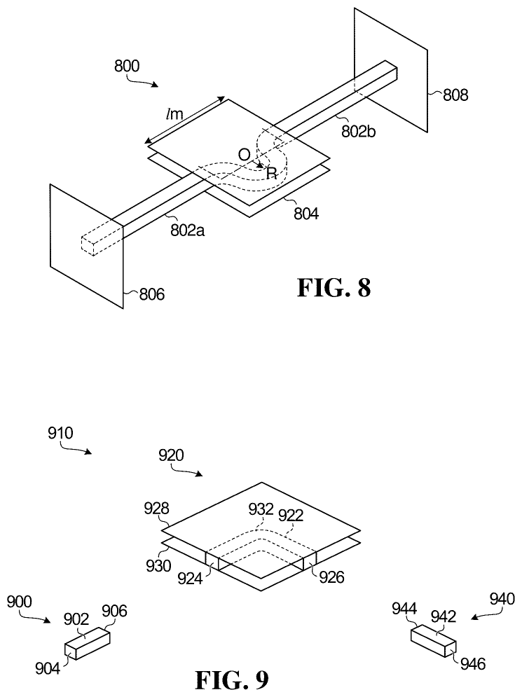

FIG. 8 shows a waveguide assembly 800 according to an embodiment of the disclosure. The waveguide assembly 800 includes a first dielectric waveguide 802a, a non-radiative dielectric waveguide 804 and a second dielectric waveguide 802b. The dielectric material of the non-radiative dielectric waveguide 804 includes four successive sharp bends of radius R centred about a point O. The bent part of the dielectric material is positioned between two conductive plates of length lm to form the non-radiative dielectric waveguide 804. The waveguide assembly 800 defines a transmission path for electromagnetic radiation between a first port 806 of the first dielectric waveguide 802a and a second port 808 of the second dielectric waveguide 802b. An electromagnetic wave may thus be received by the first dielectric waveguide 802a at the first port 806 and propagate to the second port 808 via the non-radiative dielectric waveguide 804 and the second dielectric waveguide 802b.

In the embodiment shown in FIG. 8, the waveguide assembly 800 is formed from a single strip of dielectric material. That is, the waveguide assembly 800 may have been formed by placing the conductive plates on either side of the bends in the dielectric material. In other embodiments, a waveguide assembly may be formed by connecting a dielectric waveguide to a non-radiative dielectric waveguide. An example of such a waveguide assembly is described with reference to FIG. 9.

FIG. 9 shows an exploded view of a waveguide assembly 910 according to another embodiment of the disclosure. The waveguide assembly 910 includes a first dielectric waveguide 900, a non-radiative dielectric waveguide 920 and a second dielectric waveguide 940. The waveguide assembly 910 may alternatively be referred to as a hybrid waveguide, a waveguide or a hybrid metallo-dielectric waveguide.

The first dielectric waveguide 900 comprises a first dielectric strip 902 which extends between a first end 904 of the first dielectric strip 902 and a second end 906 of the first dielectric strip 902. The first dielectric strip 902 may alternatively be referred to as a slab, rod or sheet of dielectric material. The first dielectric strip 902 may form a dielectric core.

The first dielectric strip 902 is formed from alumina with a dielectric constant of 9.8. In other embodiments, the first dielectric strip 902 may be formed from any suitable dielectric material such as any lossless dielectric material. In some examples, the first dielectric strip 902 may be formed from alumina (e.g. with a dielectric constant of 9.8 or different dielectric constant), a ceramic, silicon (e.g. high resistivity silicon, HR-Si, which may have a low loss tangent), sapphire or any combination thereof.

In this embodiment, the first dielectric strip 902 is a rectangular cuboid (e.g. a prism with a rectangular cross-section). Thus, the first dielectric strip 902 has four sides extending between the two opposing ends 904, 906. Each end 904, 906 has a flat face. In other embodiments, the ends 904, 906 might not be flat. The rectangular cuboid is rod-shaped (e.g. it is longer than it is wide). The first dielectric strip 902 may thus be described as a rectangular bar. In other embodiments, the first dielectric strip 902 may have a different shape. In some embodiments, the shape and/or size of first dielectric strip 902 may be based on reducing structural loss (e.g. by optimizing waveguide geometry).

The first and second ends 904, 906 of the first dielectric strip 902 form respective ports of the first dielectric strip 902. A port is a surface of a waveguide through which an electromagnetic wave may enter or exit the waveguide. In an example, the first end 904 may form an input port of the first dielectric waveguide 900 for receiving an electromagnetic wave and the second end 906 may form an output port the first dielectric waveguide 900 for emitting an electromagnetic wave. Thus, first dielectric waveguide 900 may form a transmission path for an electromagnetic wave from the first end 904 of the first dielectric strip 902 to the second end 906 of the first dielectric strip 902. In another example, the second end 906 may form an input port of the first dielectric waveguide 900 for receiving an electromagnetic wave and the first end 904 may form an output port the first dielectric waveguide 900 for emitting an electromagnetic wave. Thus, first dielectric waveguide 900 may form a transmission path for an electromagnetic wave from the second end 906 of the first dielectric strip 902 to the first end 904 of the first dielectric strip 902.

It will be appreciated that although waveguides are configured to allow a wave to propagate (e.g. travel) along a particular transmission path, in practice some leakage may occur. As such, references to the transmission path of a waveguide refer to the path through the waveguide that an electromagnetic wave is intended to take (e.g. based on the design or configuration of the waveguide).

As mentioned above, the first dielectric strip 902 has four sides. In other embodiments, the dielectric strip may be shaped differently and thus the first dielectric strip 902 may have more, or fewer, than four sides. In general, the sides of the first dielectric strip 902 are the faces of the first dielectric strip 902 that extend along the transmission path of the dielectric waveguide 900. Thus, the sides of the first dielectric strip 902 extend between the first end 904 and the second end 906.

The sides of the first dielectric strip 902 are exposed. That is, the sides of the first dielectric strip 902 are not covered (e.g. do not contact), even partially, by a conductor. The first dielectric strip 902 may thus be referred to as an exposed dielectric strip (e.g. the first dielectric strip). In this embodiment, the sides of the first dielectric strip 902 are exposed to air. The sides of the first dielectric strip 902 are thus in contact with air. In general, the sides of the first dielectric strip 902 may be exposed to a vacuum or any dielectric substance(s) (e.g. another dielectric material) with a permittivity that is less than the permittivity of the first dielectric strip 902. The substance(s) may be referred to as a bilateral material. Thus, the first dielectric strip 902 may be bilaterally surrounded by another dielectric material with permittivity less than the permittivity of the first dielectric strip 902. Air is just one example of the other dielectric substance that may be used.

As described in more detail below, the second end 906 of the first dielectric strip 902 is connected to a first end 924 of a bent dielectric strip 922 of the non-radiative dielectric waveguide 920. In FIG. 9, the first end 904 of the first dielectric strip 902 is shown as being uncovered e.g. not in contact with another component. In other embodiments, the first end 904 may cooperate with (e.g. contact, be coupled to and/or be connected to) another component such that an electromagnetic wave may travel (e.g. propagate) from the other component to the first dielectric waveguide 900 or vice-versa. For example, the first end 904 may be connected to another waveguide.

The non-radiative dielectric waveguide 920 includes the bent dielectric strip 922 and a first conductive plate 928, a second conductive plate 930.

The bent dielectric strip 922 extends between a first end 924 of the bent dielectric strip 922 and a second end 926 of the bent dielectric strip 922 (e.g. between two opposing ends). The first bent dielectric strip 922 may alternatively be referred to as a slab, rod or sheet of dielectric material. The first bent dielectric strip 922 may form a dielectric core.

The bent dielectric strip 922 is formed from alumina with a dielectric constant of 9.8. In other embodiments, the first dielectric strip 922 may be formed from any suitable dielectric material such as any lossless dielectric material. In some examples, the first dielectric strip 902 may be formed from alumina (e.g. with a dielectric constant of 9.8 or different dielectric constant), a ceramic, silicon (e.g. high resistivity silicon, HR-Si, which may have a low loss tangent), sapphire, or any combination thereof.

The first and second ends 924, 926 of the bent dielectric strip 922 form respective ports of the bent dielectric strip 922. Thus, a transmission path for an electromagnetic wave may be formed between the first end 924 of the bent dielectric strip 922 to the second end 926 of the bent dielectric strip 922 (e.g. as described above in respect of the first dielectric strip 902, but in respect of the bent dielectric strip 922). The first end 924 of the bent dielectric strip 922 is connected to (e.g. contacts or is coupled to) the second end 906 of the first dielectric strip 902. The first end 924 of the bent dielectric strip 922 may thus cooperate with the second end 906 of the first dielectric strip to allow an electromagnetic wave to propagate from the first dielectric waveguide 900 to the non-radiative dielectric waveguide 920, or vice-versa. As described in more detail below, the second end 926 of the bent dielectric strip is connected to (e.g. contacts or is coupled to) a first end 944 of a second dielectric strip 942.

The bent dielectric strip 922 has four sides extending between the two opposing ends 924, 926. The bent dielectric strip 922 is thus rectangular in cross-section (e.g. comprises a rectangular bar). The bent dielectric strip 922 is rod-shaped (e.g. it is longer than it is wide). The bent dielectric strip 922 may thus be described as a rectangular bar.

The bent dielectric strip 922 includes a bend 932. The bend 932 may include one or more of: a curve, a turn, a corner, a kink, an arch etc. In this embodiment, the bent dielectric strip 922 includes only a single bend. In other embodiments, the bent dielectric strip 922 may include more than one bend. In general, the bent dielectric strip 922 may include one or more bends. Thus, the bent dielectric strip 922 may have a different shape to the shape shown in FIG. 9. In some embodiments, the shape and/or size of bent dielectric strip 922 may be based on reducing structural loss (e.g. by optimizing waveguide geometry).

The presence of the bend 932 in the bent dielectric strip 922 changes, at least temporarily, the transmission direction of an electromagnetic wave propagating through the non-radiative dielectric waveguide 920. Thus, the transmission path through the non-radiative dielectric wave guide 920 may also be described as bent (e.g. a bent transmission path or a transmission path having at least one bend, in which bend is defined above).

The bend may have any suitable radius (e.g. of curvature). The implementation of a non-radiative waveguide at a bend of a waveguide assembly for an electromagnetic wave in accordance with the present disclosure may be particularly advantageous for a bend with a radius of curvature that is less than or equal to the wavelength of the electromagnetic wave. In contrast to a dielectric waveguide, a non-radiative dielectric waveguide allows sharp discontinuities such as bends with a small curvature of one wavelength or even less. This allows for reducing the size of the waveguide assembly (and thus any system into which it is integrated) whilst minimising losses.

The bent dielectric strip 922 is between the first conductive plate 928 and the second conductive plate 930. Thus, a first side of the bent dielectric strip 922 contacts the first conductive plate 928 and a second, opposing, side of the bent dielectric strip 922 contacts the second conductive plate 930. That is, one of the conductive plates 928, 930 contacts one of the faces of the bent dielectric strip 922 that extends along the transmission path of the non-radiative dielectric waveguide 920 and another of the conductive plates 928, 930 contacts another of the faces of the bent dielectric strip 922, such that the bent dielectric strip 922 is sandwiched between the two conductive plates 928, 930. As two sides of the bent dielectric strip 922 are covered by the conductive plates 928, 930, the bent dielectric strip 922 may alternatively be referred to as the covered dielectric strip.

Each of the conductive plates 928, 930 comprises a sheet of conductive material (e.g. a sheet of a conductor). The plates 928, 930 are planar (e.g. substantially flat). The plates 928, 930 have substantially the same shape as one another. The plates 928, 930 may thus be described as a pair of plates 928, 930 (e.g. a corresponding pair of plates). The first and second conductive plates 928, 930 are parallel to one another. Thus, the first and second conductive plates 928, 930 form a pair of parallel plates that are spaced apart by the bent dielectric strip 922.

Each of the first and second conductive plates 928, 930 covers an area that is larger than the respective side of the bent dielectric strip 922 that it contacts. Each of the first and second conductive plates 928, 930 covers (e.g. completely covers) and extends beyond a respective side of the dielectric strip 922. As the plates 928, 930 are planar, this leaves two sides of the bent dielectric strip 922 exposed (e.g. uncovered by the conductive plates 928, 930). Thus, a gap is formed between the conductive plates 928, 930 on either side of the dielectric strip 922. In the illustrated embodiment, this gap is filled with air (e.g. there is an air gap between the conductive plates 928, 930 on each side of the bent dielectric strip 922). Thus, two opposing sides of the bent dielectric strip 922 are in contact with air. This may be described as the dielectric strip 922 being bilaterally surrounded by air overlays. In general, the sides of the bent dielectric strip 922 that are not in contact with the conductive plates 928, 930 may be exposed to a vacuum or any dielectric substance(s) (e.g. another dielectric material) with a permittivity that is less than the permittivity of the bent dielectric strip 922. The substance(s) may be referred to as a bilateral material. Thus, the bent dielectric strip 922 may be bilaterally surrounded by another dielectric material with permittivity less than the permittivity of the bent dielectric strip 922. Air is just one example of the other dielectric substance(s) that may be used.

The large contrast between the permittivity of the bent dielectric strip 922 and the bilateral material causes the electromagnetic field of any electromagnetic wave propagating through the bent dielectric strip 922 to decay exponentially outside of the bent dielectric strip 922. At the edge of the plates 928, 930, the electromagnetic field should be practically negligible. This prevents the electromagnetic wave from propagating outside of the bent dielectric strip 922, even at the bend 932. Therefore, the non-radiative waveguide 920 reduces losses at the bend 932.

One or more of the conductive plates 928, 930 may be formed solely from a conductive material. Alternatively, one or more of the conductive plates 928, 930 may comprise a layer of conductive material applied to another (e.g. dielectric or non-conductive) material. The conductive plates 928, 930 may comprise the same conductive material or might comprise different conductive materials. Any suitable conductive materials may be used. One or more of the conductive plates 928, 930 may be formed from metal, such as copper, gold or aluminium. Copper may be particularly advantageous when there is no oxygen (e.g. when the conductive plates 928, 930 are in an environment with little or no oxygen) because the lack of oxygen may prevent the formation of copper oxide. As copper oxide has a higher conductor loss, this may further reduce the losses of the non-radiative waveguide 920. The conductive plates 928, 930 may, for example, comprise metal plates or metallic plates. The conductive plates 928, 930 may form part of a conductive, metal or metallic housing (e.g. a housing for the bent dielectric strip 922). The conductive plates 928, 930 may comprise metal bridges, conductive bridges or metallic bridges. In some embodiments, one or more of the conductive plates 928, 930 may be formed from a superconducting material.

The second dielectric waveguide 940 comprises a second dielectric strip 942 which extends between a first end 944 of the second dielectric strip 942 and a second end 946 of the second dielectric strip 942.

In this embodiment, the second dielectric waveguide 940 is the same as the first dielectric waveguide 900 except for its orientation, and thus will not be discussed in detail. As illustrated in FIG. 9, the first dielectric waveguide 900 is connected to the first end 924 of the non-radiative dielectric waveguide 920 and the second dielectric waveguide 940 is connected to the second end 926 of the non-radiative dielectric waveguide 920, in which the non-radiative waveguide 920 includes a 90 degree bend. As a result, the second dielectric waveguide 940 is substantially perpendicular to the first dielectric waveguide 900. In other embodiments, the non-radiative waveguide 920 may include a bend with a different radius of curvature and/or one or more other bends, which may change the relative orientation of the second dielectric waveguide 940 relative to the first dielectric waveguide 900.

In other embodiments, the second dielectric waveguide 940 might be different to the first dielectric waveguide 900. For example, the second dielectric waveguide 940 may be different to the first dielectric waveguide 900 in shape and/or size. In general, the second dielectric waveguide 940 may include some or all of the features described above in respect of the first dielectric waveguide 900.

The first and second ends 944, 946 of the second dielectric strip 942 form respective ports of the second dielectric strip 942. Thus, a transmission path for an electromagnetic wave may be formed between the first end 944 of the second dielectric strip 942 to the second end 946 of the second dielectric strip 942 (e.g. as described above in respect of the first dielectric strip 902, but in respect of the second dielectric strip 942). The first end 944 of the second dielectric strip 942 is connected to (e.g. contacts or is coupled to) the second end 926 of the bent dielectric strip 922. The first end 944 of the second dielectric strip 942 may thus cooperate with the second end 926 of the bent dielectric strip 922 to allow an electromagnetic wave to propagate from the non-radiative dielectric waveguide 920 to the second dielectric waveguide 940, or vice-versa.

In FIG. 9, the second end 946 of the second dielectric strip 942 is shown as being uncovered e.g. not in contact with another component. In other embodiments, the second end 946 may cooperate with (e.g. contact, be coupled to and/or be connected to) another component such that an electromagnetic wave may travel (e.g. propagate) from the other component to the second dielectric waveguide 940 or vice-versa. For example, the second end 946 may be connected to another waveguide.

As described above, the first dielectric waveguide 900, the non-radiative dielectric waveguide 920 and the second dielectric waveguide 940 are connected to form a waveguide assembly 910. The connections between the first dielectric waveguide 900, the non-radiative dielectric waveguide 920 and the second dielectric waveguide 940 form a transmission path for an electromagnetic wave through the waveguide assembly 910. The waveguide assembly 910 may thus operate as a transmission line to transfer energy from one side to another side, or distribute energy to desired directions.

By using a non-radiative dielectric waveguide 920 for the bend 932 and dielectric waveguides 900, 940 elsewhere, the waveguide assembly 910 reduces the radiative losses at the bend 932 whilst avoiding metallic losses elsewhere. The use of the non-radiative dielectric waveguide 920 for the bend may allow for significantly reducing the dimension of components by avoiding smooth but bulky transitions. The non-radiative dielectric waveguide 920 may be particularly advantageous compared to other waveguides that include a conductive material (e.g. compared to other metal-based waveguides) because it has excellent loss behaviour, particularly when operating in the LSMₒ₁^{x} mode. In addition, the dielectric waveguide may provide acceptable loss performance elsewhere. The waveguide assembly 910 can thus achieve reduced propagation loss without necessitating an increase in size. The waveguide assembly may thus be used to design compact bends, dividers, couplers, crossovers, etc.

The transmission path through the waveguide assembly 910 may be for any suitable electromagnetic wave. The electromagnetic wave may comprise, for example, a radio wave, a microwave, a millimeter-wave, a THz wave or an optical wave. The waveguide assembly 910 may be particularly advantageous for a THz wave, or for implementation in a THz system, because existing waveguides may be particularly loss-sensitive over the THz band. The electromagnetic wave may alternatively be referred to as electromagnetic radiation. Thus, the transmission path through the waveguide assembly 910 may be for any suitable electromagnetic radiation.

### Integrally Formed Dielectric Strips

In the embodiment shown in FIG. 9, the first dielectric strip 902, the bent dielectric strip 922 and the second dielectric strip 942 are separate parts. Some or all of the first dielectric strip 902, the bent dielectric strip 922 and the second dielectric strip 942 may be formed from different (dielectric) materials, for example. In other embodiments, two or more of the first dielectric strip 902, the bent dielectric strip 922 and the second dielectric strip 942 may be integrally formed (e.g. as in the waveguide assembly 800). Thus, the first dielectric strip 902, the bent dielectric strip 922 and the second dielectric strip 942 may be sections of a single dielectric strip (e.g. a length, slab, rod or sheet). The first dielectric strip 902, the bent dielectric strip 922 and the second dielectric strip 942 may thus alternatively be referred to as a first dielectric section, a bent dielectric section and a second dielectric section. It may be particularly advantageous to integrally form the first dielectric strip 902, the bent dielectric strip 922 and the second dielectric strip 942 as this may improve continuity between the dielectric strips and thus further reduce losses.

### Multiple Pairs of Plates

In the embodiment shown in FIG. 9, the bent dielectric strip 922 comprises only a single bend 932 and the bend 932 is sandwiched between a pair of conductive plates 928, 930. As mentioned above, in other embodiments, the bent dielectric strip 922 may include more than one bend. In those embodiments, the pair of conductive plates 928, 930 may extend over more than one bend (e.g. over each of the bends). Alternatively, separate pairs of conductive plates 928, 930 may be provided for each bend. Thus, each bend may be positioned (e.g. held or sandwiched) between a respective pair of conductive plates.

### Bent Dielectric Waveguide

In the embodiment shown in FIG. 9, the non-radiative waveguide 920 includes a bent dielectric strip 922, whilst the first and second dielectric strips 902, 942 in the first and second dielectric waveguides 900, 940 are straight. In other embodiments, one or more of the first and second dielectric strips 902, 942 may include a bend with a radius of curvature that is larger than the radius of curvature of the bend in the bent dielectric strip 922. That is, the bent dielectric strip 922 may be bent relative to first and second dielectric strips 902, 942. The radiative losses from a dielectric waveguide that includes a bend may be minimised by increasing the radius of curvature of the bend (e.g. by softening or smoothing the bend). Therefore, in some embodiments, a dielectric waveguide may be used for a smoother bend (with a larger radius of curvature) and a non-radiative waveguide may be used for a sharper bend (with a smaller radius of curvature). This may be particularly advantageous for systems in which performance (e.g. minimising losses) is more important than size.

### One or More Dielectric Waveguides

In the embodiment shown in FIG. 9, the waveguide assembly 910 includes a first dielectric waveguide 900 and a second dielectric waveguide 940 on either side of the non-radiative dielectric waveguide 920. In another embodiment, one of the first and second dielectric waveguides 900, 940 may be omitted. Thus, the waveguide assembly may comprise the non-radiative dielectric waveguide 920 and only one other dielectric waveguide (e.g. the first dielectric waveguide 900 or the second dielectric waveguide 940). In yet another embodiment, the waveguide assembly 910 may include one or more other dielectric waveguides in addition to first dielectric waveguide 900 and the second dielectric waveguide 940. In general, the waveguide assembly 910 may include one or more dielectric waveguides (e.g. with some or all of the features of the first dielectric waveguide 900 or the second dielectric waveguide 940) in addition to the non-radiative dielectric wave guide 920.

### Discontinuities

In general, radiative losses may occur at any discontinuity in a dielectric waveguide. A bend is an example of a discontinuity. Another example of a discontinuity is a connection between two components or two modules. For example, a discontinuity may occur at a connection between two dielectric waveguides. In general, the radiative losses at a discontinuity may be reduced by implementing a non-radiative waveguide at a discontinuity.

Therefore, in another aspect of the present disclosure, another waveguide assembly is provided. The waveguide assembly comprises a non-radiative dielectric waveguide and a dielectric waveguide. The non-radiative dielectric waveguide may be substantially the same as the non-radiative dielectric waveguide 920 described above, except that the non-radiative dielectric waveguide according to this embodiment includes a discontinuity, which may be a bend or might not be a bend. Thus, for example, the non-radiative dielectric waveguide in this embodiment may comprise the bent dielectric strip 932 between the first and second conductive plates 928, 930. Alternatively, the non-radiative dielectric waveguide comprise a dielectric strip having a different discontinuity, such as a connection between a first part of the dielectric strip and a second part of the dielectric strip, in which the dielectric strip is between a first conductive plate (e.g. the first conductive plate 928) and a second conductive plate (e.g. the second conductive plate 930). The second conductive plate may be parallel to the first conductive plate such that the first and second parallel plates form a pair of parallel conductive plates.

Thus, similar to the waveguide assembly 910 described above, the discontinuity may be sandwiched between a pair of parallel conductive plates to form a non-radiative dielectric waveguide. An end of the non-radiative dielectric waveguide may be connected to the dielectric waveguide in the waveguide assembly to form a transmission path for an electromagnetic wave through the first dielectric waveguide and the first non-radiative dielectric waveguide.

Therefore, the waveguide assembly 910 described above may be generalised to a waveguide assembly in which a non-radiative dielectric waveguide it implemented at (e.g. over) a discontinuity and a dielectric waveguide is implemented elsewhere. This may reduce propagation losses at discontinuities in a system.

### Coupling Efficiency

In order to verify the implementation of the waveguide assembly described herein, it was first verified that a wave could be effectively coupled from a dielectric waveguide (e.g. the first or second dielectric waveguides 900, 940) to a non-radiative dielectric waveguide (e.g. the non-radiative dielectric waveguide 920) and vice-versa. As different waveguides support different modes, it might not always be possible to effectively couple a wave from one waveguide to another. Therefore, the mode compatibility of the dielectric waveguide and the non-radiative dielectric waveguide was investigated.

In the THz band, the fundamental modes supported by a non-radiative dielectric waveguide are the LSE₁₁ and LSM₀₁ modes. The LSE₁₁ and LSM₀₁ modes are non-radiative and have a parallel electrical field, so they propagate along the dielectric strip in the non-radiative dielectric waveguide (e.g. they propagate along the core), but are cut off outside. The fundamental modes supported by a dielectric waveguide are the E₁₁^{y} and E₁₁^{x} modes.

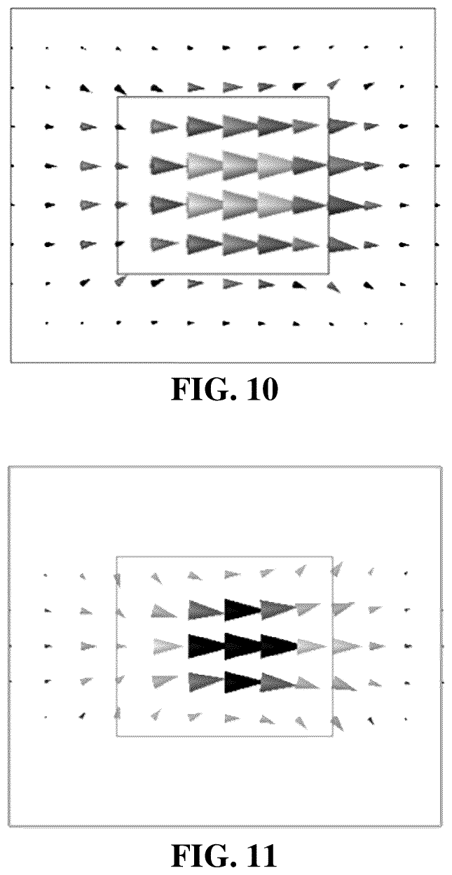

FIG. 10 shows the transverse electric field pattern of the E₁₁^{x} mode of a dielectric waveguide. FIG. 11 shows the LSMₒ₁^{x} mode of a non-radiative dielectric waveguide. As shown in FIGS. 10 and 11, the transverse electric field patterns of the E₁₁^{x} mode and the LSMₒ₁^{x} mode show a great similarity with each other, which is an important factor for effective coupling. It was discovered that the E₁₁^{x} mode of the dielectric waveguide shows mode compatibility with the non-radiative LSMₒ₁^{x} mode of the non-radiative dielectric waveguide. However, the E₁₁^{y} mode of the dielectric waveguide does not show mode compatibility with the non-radiative LSMₒ₁^{x} mode of the NRD waveguide. Therefore, it may be preferred to drive the waveguide assembly of the present disclosure with the E₁₁^{x} mode.

To further evaluate the coupling efficiency between a non-dielectric waveguide and a dielectric waveguide, a first test dielectric waveguide and a first test non-radiative dielectric waveguide were constructed. The first test dielectric waveguide comprised a length of dielectric material with length l, width w=0.3 mm and height h=0.254. The first test dielectric waveguide was straight (e.g. had no bends). The first test non-radiative dielectric waveguide comprised the first test dielectric waveguide sandwiched between two gold plates (e.g. two gold substrates). The first test dielectric waveguide was formed from alumina with a permittivity of 9.8. The test waveguides were tested using waves in the WR3 band (e.g. in the frequency range 220-330 GHz). These parameters were chosen based on the considerations that the frequency response of the E₁₁^{x} mode is expected to be dominantly determined by the width of the dielectric strip, the requiring of working at a single-mode operating region and fine wave confinement.

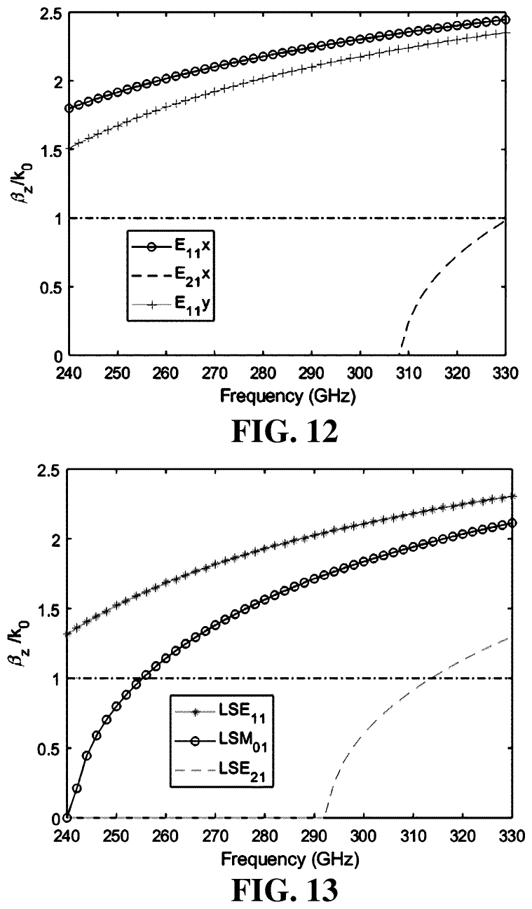

FIG. 12 shows the dispersion curves of the first test dielectric waveguide for the E₁₁^{x} mode (circles), the E₂₁^{x} mode (dashed line) and the E₁₁^{y} mode (crosses) for frequencies in the range 240-330 GHz. The dot-dashed line indicates β_{z}/k₀=1, which corresponds to the wave being confined inside the dielectric. When β_{z}/k₀<1, the dielectric strip still supports the wave propagation, but the wave may be loosely confined, which risks crosstalk between adjacent channels. β_{z} is the longitudinal propagation constant (e.g. the propagation constant along the direction of propagation). k₀ is the wavenumber in free space. FIG. 12 shows that the E₁₁^{x} mode can propagate in the first test dielectric waveguide, indicating that the E₁₁^{x} mode is suitable for a dielectric waveguide.

FIG. 13 shows the dispersion curves of the first test non-radiative dielectric waveguide for the LSE₁₁ mode (diamonds), LSM₀₁ mode (circles) and the LSE₂₁ mode (dashed line) for frequencies in the range 240-330 GHz. The dot-dashed line indicates β_{z}/k₀=1. FIG. 13 shows that the first test non-radiative dielectric waveguide can also work in the WR3 band. However, as indicated by FIG. 6, the function of the LSM₀₁^{x} declines significantly below 255 GHz because of high metal loss and loose wave confinement. This can be addressed by increasing the width of the dielectric strip in the non-radiative dielectric waveguide. Therefore, it may be particularly advantageous to increase the width of the dielectric strip in the non-radiative dielectric waveguide for frequencies below 255 GHz.

Therefore, FIGS. 12 and 13 show that the first test dielectric waveguide and the first test non-radiative dielectric waveguide operate in the WR3 band. To determine the coupling coefficient, and thus test the coupling, between a dielectric waveguide and a non-radiative dielectric waveguide in accordance with aspects of the disclosure, a simulation of a waveguide assembly was produced. In the simulated waveguide assembly, an ideal wave port was included at one end of first test dielectric waveguide and coupled to an ideal wave port at an end of the test non-radiative dielectric waveguide. For simplicity, material loss was ignored.

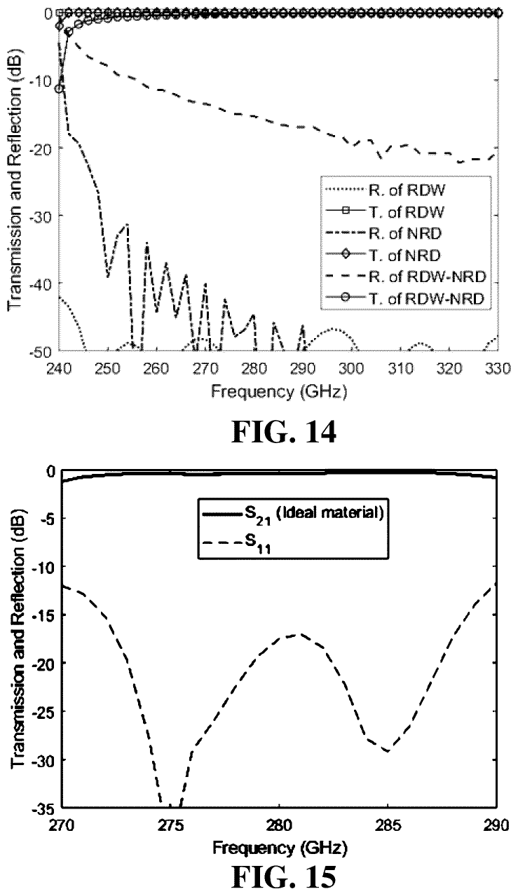

FIG. 14 shows the transmission (solid line with circles) and reflection (dashed line) of the waveguide assembly in decibels (dB). The transmission and reflection of the first test dielectric waveguide alone (RDW) and the first test non-radiative dielectric waveguide (NRD) alone are also shown.

The high transmission of the waveguide assembly in FIG. 14 demonstrated that a wave can be efficiently coupled from the first test dielectric waveguide to the first test non-radiative dielectric waveguide. The reflection of the waveguide assembly shown in FIG. 14 illustrates that there is a loss of around 0.15 dB from 260 GHz to 330 GHz. However, this is negligible compared to the transmission. In any case, this operating bandwidth is tunable by adjusting the non-radiative waveguide.

FIGS. 10-14 thus illustrate that a wave may be effectively coupled from a dielectric waveguide to a non-radiative dielectric waveguide.

Next, the impact of using a non-radiative waveguide at a bend was investigated. To investigate this, a second test waveguide assembly comprising the first test dielectric waveguide coupled to a second test non-radiative dielectric waveguide was simulated. The second test non-radiative dielectric waveguide comprised a dielectric strip having four bends, in which two parallel metal plates sandwich the bends in the dielectric strip. Thus, the second test non-radiative dielectric waveguide had the structure of the portion of the waveguide assembly 800 between the length l. In this simulation, the curvature of the bend was set to R=0.2 mm for all four bends. The metal plates fully covered the four bends with an area of 1 mm×1 mm. FIG. 15 shows the transmission from the input port of the first dielectric waveguide to the output port of the second test non-radiative dielectric waveguide (e.g. the transmission through the waveguide). This is labelled as S₂₁. The simulation assumes no material loss. FIG. 15 also shows the reflection of the waveguide, e.g. the power that is input to the input port of the first dielectric waveguide and received back at the input. This is labelled as S₁₁. As shown in FIG. 15, the reflection coefficient is less than-10 dB is from 270 GHz to 290 GHz, indicating that there is minimal reflection. The maximum insertion loss is 0.5 dB. This insertion loss is expected to be caused by the reflection at the two interfaces between the first test dielectric waveguide and the second test non-radiative dielectric waveguide.

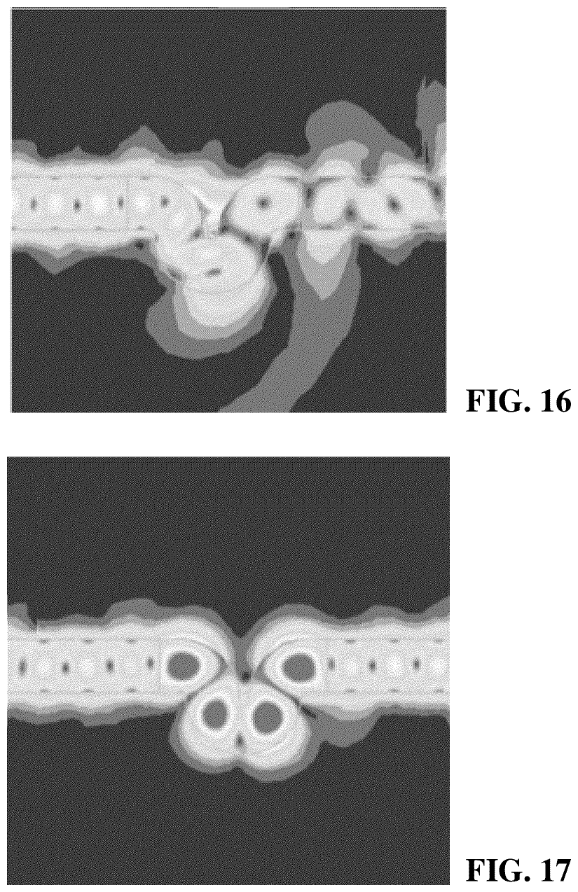

The impact of including the metal plates at the bend (e.g. using the non-radiative dielectric waveguide rather than a dielectric waveguide) is shown more clearly in FIG. 16 and FIG. 17. FIG. 16 shows the field distribution over the bending area (e.g. over the four bends described above) at 280 GHz in the absence of the metal plates. FIG. 17 shows the field distribution over the bending area at 280 GHz when metal plates are used. Comparing these two drawings illustrates that the significant radiation leakage that occurs when plates are omitted is well controlled by sandwiching the bends between metal plates. Therefore, a non-radiative dielectric waveguide is an effective way to suppress radiation leakage at a bend, even for bends with radii as small as R=0.2 mm.

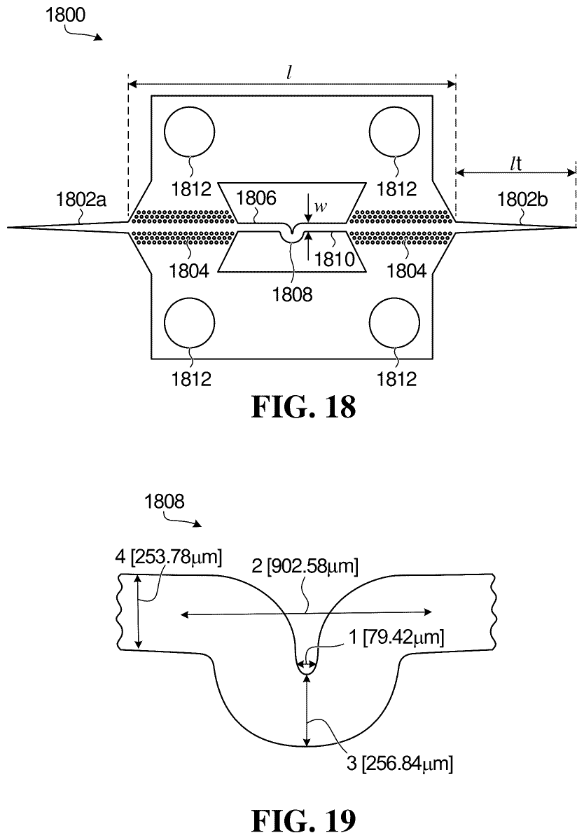

To further verify the waveguide assembly of the present disclosure, a waveguide assembly in accordance with aspects of the present disclosure was fabricated and tested. The fabricated waveguide assembly and the associated results are described with reference to FIGS. 18-22.

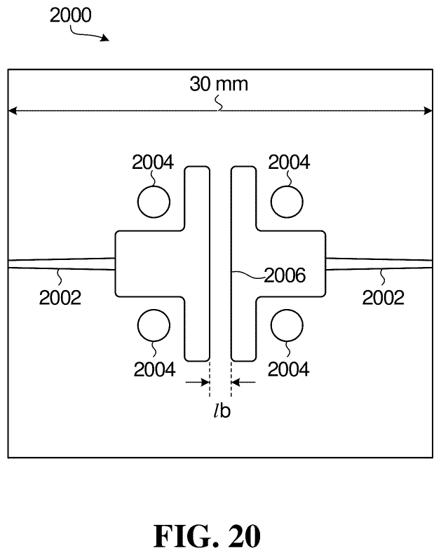

FIG. 18 shows a dielectric structure 1800 according to an embodiment of the disclosure. The dielectric structure 1800 includes first and second tapers 1802a, 1802b, air-hole perforated dielectric substrate 1804, a dielectric strip having a first straight portion 1806, a bent portion 1808 of the dielectric strip, and a second straight portion 1810, and four holes 1812. FIG. 19 shows the bent portion 1808 of the dielectric strip in more detail. FIG. 20 shows a metallic housing 2000 comprising two tapered channels, 2002, and four holes 2004 and a pair of metallic plates 2006 (although only one is shown) according to the embodiment of the disclosure.

The dielectric structure 1800 was formed by laser drilling a single piece of ceramic. The dielectric structure 1800 includes a body from which the tapers 1802a, 1802b of the dielectric structure 1800 extend horizontally on opposing sides. The tapers 1802a, 1802b are for matching between the dielectric structure 1800 and rectangular metallic waveguide in measurement. The body of the dielectric structure 1800 is bilaterally supported by the air-hole perforated dielectric substrate 1804. The tapers 1802a, 1802b have length lt=3.5 mm. The length of the body is l=10 mm.

The first taper 1802a, the dielectric strip and the second taper 1802b are connected to form a dielectric core. The first taper 1802a is connected to the first straight portion 1806 of the dielectric strip by a section of dielectric material. The air-hole perforated dielectric substrate 1804 are positioned above and below the section of dielectric material between the first taper 1802a and the first straight portion 1806 of the dielectric strip. Similarly, the second taper 1802b is connected to the second straight portion 1810 of the dielectric strip by another section of dielectric material. The air-hole perforated dielectric substrate 1804 is positioned above and below the other section of dielectric material between the second taper 1802b and the second straight portion 1810 of the dielectric strip. The air-hole perforated dielectric substrate 1804 reduces the permittivity of the other parts of the body adjacent to the dielectric core, which allows for supporting the forming the support for the dielectric core from the same substrate.

The dielectric strip is suspended in a cavity of the body, defining an upper cavity above the dielectric strip and a lower cavity below the dielectric strip. The first straight portion 1806 of the dielectric strip is connected to the bent portion of the dielectric strip 1808, which is connected to the second straight portion 1810 of the dielectric strip. Thus, the first straight portion 1806, bent portion 1808 and the second straight portion 1810 form the dielectric strip, with the bent portion part between the first straight portion 1806 and the second straight portion 1810. The first and second straight portions 1806, 1810 of the dielectric strip have a width w=0.3 mm.

The dimensions of the bent portion 1808 of the dielectric strip are shown in FIG. 19. The bent portion 1808 includes four bends. The length across the bent portion 1808 (e.g. the distance between the first straight portion 1806 and the second straight portion 1810) is 902.58 microns. The width of the dielectric strip incoming to the bent portion 1808 is 253.78 microns. The width of the dielectric strip at the centre of the bent portion 1808 is 256.84 microns. The separation between two facing sides of the bent portion 1808 is 79.42 microns.

The metallic housing 2000 comprises an aluminium substrate that is 30 mm across. The metallic housing 2000 was fabricated using micromachining. The two tapered channels 2002 of the metallic housing 2000 work as transitions between the air-filled waveguide and the dielectric core. The pair of metallic plates 2006, which may also be referred to as metallic bridges, are for positioning on either side of the bend when the waveguide assembly is assembled. The metallic plates 2006 are suspended in the metallic housing 2000 such that there are gaps (e.g. holes) in the metallic housing 2000 on either side of the metallic plates 2006. The metallic plates 2006 thus extend across a cavity in the metallic housing 2000. The metallic plates 2006 are integrally formed in the metallic housing 2000. Each of the metallic plates 2006, has a width lb=1 mm.

The fabricated waveguide assembly was assembled by inserting the dielectric structure 1800, supported at the ends of the air-hole perforated dielectric substrate 1804, into the metallic housing 2000. The four holes 1812 of the dielectric structure 1800 were aligned with the four holes 2004 of the metallic housing 2000. The dielectric structure 1800 was fixed in placed by inserting a pin into each pair of aligned holes. The dielectric structure 1800 was positioned in the metallic housing 2000 such that the metallic plates 2006 of the metallic housing 2000 covered the bent portion 1808 of the dielectric strip, leaving the first and section straight portions 1806, 1810 of the dielectric strip exposed. Thus, once assembled, the bent portion 1808 of the dielectric strip of the dielectric structure 1800 was sandwiched between the two metallic plates 2006 to form a non-radiative dielectric waveguide. The first and second straight portions 1806, 1810 of the dielectric strip were left exposed to form dielectric waveguides on either side of the non-radiative dielectric waveguide. Any part of the metallic housing 2000 that might otherwise have been underneath or below the first and second straight portions 1806, 1810 of the dielectric strip were removed to ensure that the straight portions 1806, 1810 would not exhibit conductor loss.

The transmission performance of the fabricated waveguide assembly was investigated using a PNA-X network analyzer N5247. A pair of VDI frequency extenders were used to increase the frequency band from 215 GHz to 335 GHz. The Thru-Reflect-Line (TRL) calibration method was used to calibrate for any system error.

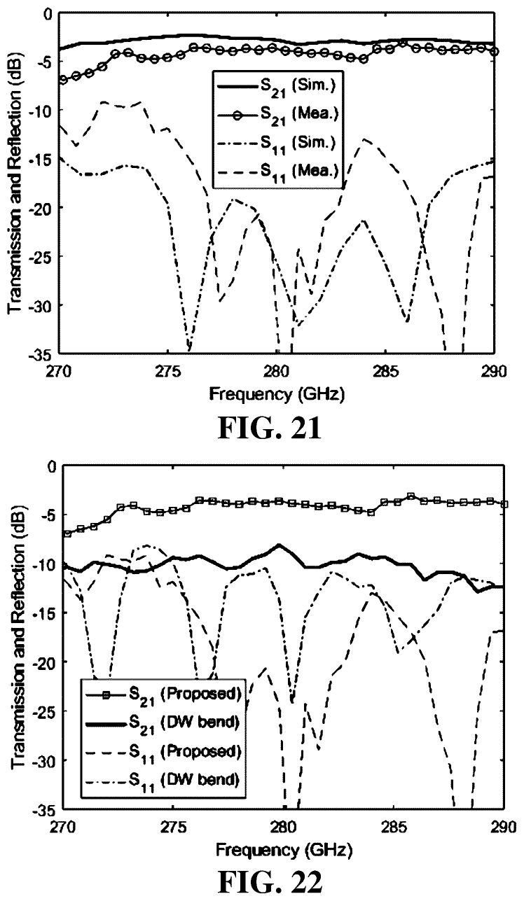

FIG. 21 shows the simulated (Sim.) transmission of the fabricated waveguide assembly (Sim.; solid line, no marker) and the measured (Mea.) transmission of the fabricated waveguide assembly. (S₂₁; solid line with circles). The simulated reflection (Su Sim., dot-dashed line) and the measured reflection (Su Mea.; dashed line) of the fabricated waveguide assembly are also shown. The simulated averaged insertion loss is 2.7 dB from 270 GHz to 290 GHz. This is expected to include material losses, reflection loss from interfaces and feeding loss. The tangent loss of alumina is tan 8=0.001. The material used for metallic house is aluminum. The simulated reflection coefficient is less than-15 dB within the bandwidth considered. There is some discrepancy between the simulated results and the measured results. It is expected that this may be due to surface roughness of the dielectric structure 1800 and the metallic housing 2000, as this may increase insertion loss.

FIG. 22 shows the transmission of the fabricated waveguide assembly (S₂₁ Proposed; solid line, square marker) and the transmission of the dielectric structure 1800 alone (S₂₁ DW bend; solid line, no marker) e.g. with the metallic plates 2006 removed. The reflection of the fabricated waveguide assembly (Su Proposed; dashed line) and the reflection of the dielectric structure 1800 alone (S₁₁ DW bend; dot-dashed line) are also shown. As illustrated, the transmission is higher for the fabricated waveguide assembly, indicating that the presence of the metallic plates 2006 is reducing radiative losses. FIG. 22 shows that the wave can hardly be guided through sharp bends without the metallic plates 2006. Therefore, in the absence of the metallic plates 2006, it may be necessary to increasing the curvature of the bend.

This illustrated that a non-radiative waveguide may be implemented at a bend in order to minimise radiative losses. This allows for reducing the radius of curvature of the bend whilst minimising losses. As shown herein, implementing a non-radiative waveguide at a bend may allow for decreasing the radius of curvature of the bend in a THz waveguide from R=2 mm to R=0.2 mm. In practice, a system includes aspects of the present disclosure may be designed by balancing the compactness of the system and with bandwidth requirements for different scenarios. In some examples, non-radiative waveguides may be implemented at as few bends (or, more generally, discontinuities) as possible in order to minimise the number of interfaces between different types of waveguides and thus minimise reflection loss due to the interfaces. In particular examples, a non-radiative waveguide may only be implemented at a bend with a radius of curvature below a maximum value, for example. This may allow for balancing the need for a compact system whilst still minimising losses.

### Junctions

Aspects of the present disclosure may be used to implement junctions, such as dividers (or splitters), couplers, crossovers etc. A junction may be used to combine two or more waves (e.g. in a waveguide combiner). A junction may alternatively be used to divide (or split) a wave into two or more parts (e.g. in a waveguide divider). A junction may thus be a waveguide assembly having two or more branches, in which each branch defines a respective transmission paths. For simplicity, embodiments of the disclosure will be described with reference to junctions with two transmission branches, but it will be appreciated that the features described herein may be adapted for junctions with more than two transmission branches.

According to aspects of the present disclosure, a waveguide assembly may comprise a non-radiative dielectric waveguide at a bend in a junction of the waveguide assembly and a dielectric waveguide elsewhere.

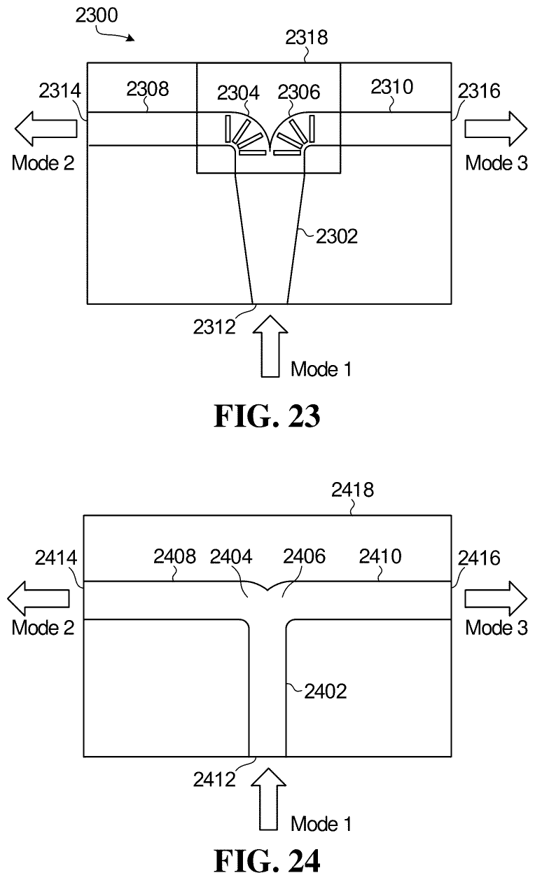

A waveguide assembly 2300 according to an embodiment of the disclosure is shown in FIG. 23.

The waveguide assembly 2300 includes a first exposed dielectric strip 2302, a first bent dielectric strip 2304, a second bent dielectric strip 2306, a second exposed dielectric strip 2308 and a third exposed dielectric strip 2310.

The waveguide assembly 2300 has an input port 2312 at one end of the first exposed dielectric strip 2302, a first output port 2314 at one end of the second exposed dielectric strip 308 and a second output port 2316 at one end of the third exposed dielectric strip 2310. The first exposed dielectric strip 2302, the first bent dielectric strip 2304 and the second exposed dielectric strip 2308 form a first branch of the waveguide assembly 2300. The first exposed dielectric strip 2402, the second bent dielectric strip 2306 and the third exposed dielectric strip 2310 form a second branch of the waveguide assembly 2300. Thus, waves input to the waveguide assembly 2300 at the input port 2312 may propagate along a first transmission path to be output at the first output port 2314 e.g. travelling along the first branch, or along a second transmission path to be output at the second output port 2316 e.g. travelling along the second branch. The waveguide assembly 2300 thus forms a waveguide divider.

The waveguide assembly also includes a pair of parallel conductive plates 2318. The parallel conductive plates 2318 may correspond substantially to the second conductive plates 928, 930 described above, except that both the first bent dielectric strip 2304 and the second bent dielectric strip 2306 are sandwiched between the parallel conductive plates 2318. Thus, the pair of parallel conductive plates 2318 cover both the first bent dielectric strip 2304, and the second bent dielectric strip 2306 to form a first non-radiative dielectric wave guide and a second non-radiative waveguide. The first, second and third exposed dielectric strips 2302, 2308, 2310 are left uncovered by the parallel conductive plates 2318 (e.g. are left exposed), and thus form a first dielectric waveguide, a second dielectric waveguide and a third dielectric waveguide. Therefore, the waveguide assembly 2300 may be referred to as a hybrid waveguide divider.

The waveguide assembly 2300 thus comprises a first branch and a second branch. The first branch is formed from a first dielectric waveguide (formed from the first exposed dielectric strip 2302), a first non-radiative dielectric waveguide (formed from the first bent dielectric strip 2304 and the parallel plates 2318), and second dielectric waveguide (formed from the second exposed dielectric strip 2308). The second branch is formed from the first dielectric waveguide (formed from the first exposed dielectric strip 2302), a second non-radiative dielectric waveguide (formed from the second bent dielectric strip 2306 and the parallel plates 2318), and third dielectric waveguide (formed from the third exposed dielectric strip 2310).

In use, the waveguide assembly 2300 may receive electromagnetic waves at the input port 2312 at Mode 1. At least some of the electromagnetic waves may propagate along the first branch to be output at the first output port 2314 at Mode 2. The rest of the electromagnetic waves may propagate along the second branch to be output at the second output port 2316 at Mode 3. In this example, Mode 1, Mode 2 and Mode 3 are En.

As illustrated in FIG. 23, there are slots in the conductive plates 2318 over each of the bends 2304, 2306. There is a set of slots over each bend 2304, 2306, in which each set of slots includes four slots. In other examples, more or fewer slots may be used. In general, each set of slots may include one or more slots. These slots are cut (e.g, etched) into one of the parallel plates 2318, exposing part of the first bent dielectric strip 2304 and part of the second bend dielectric strip 2306. These slots are used to suppress mode conversion between an LSM₀₁ mode and an LSE₁₁ mode over the bends 2304, 2306. As a result, the mode propagating inside the bends 2304, 2306 is always the LSM₀₁ mode, which allows for effective coupling with the dielectric waveguides formed by the second and third exposed dielectric strips 2308, 2310.

This may be explained in more detail with respect to FIG. 24, which shows an example of a non-radiative dielectric waveguide 2400 according to embodiments of the disclosure.

The non-radiative dielectric waveguide 2400 includes a first straight dielectric strip 2402, a first bent dielectric strip 2404, a second bent dielectric strip 2406, a second straight dielectric strip 2408, a third straight dielectric strip 2410, and a pair of parallel conductive plates 2418. The waveguide assembly has an input port 2412 at one end of the first straight dielectric strip 2402, a first output port 2414 at one end of the second straight dielectric strip 2408 and a second output port 2416 at one end of the third straight dielectric strip 2410.

The parallel conductive plates 2418 may correspond substantially to the parallel conductive plates 2318 described above, except that all of the first straight dielectric strip 2402, first bent dielectric strip 2404, second bent dielectric strip 2406, second straight dielectric strip 2408, and third straight dielectric strip 2410, are sandwiched between the parallel conductive plates 2418.

The waveguide assembly 2400 may have the features of the waveguide assembly 2300 described above, except for the differences outlined below. Thus, the first exposed dielectric strip 2402, the first bent dielectric strip 2404, the second bent dielectric strip 2406, the second exposed dielectric strip 2408, the third exposed dielectric strip 2410, and the pair of parallel plates 2418 may be substantially the same as the corresponding elements of the waveguide assembly 2300 described above, except . . . .

In use, the non-radiative dielectric waveguide 2400 may receive electromagnetic waves at the input port 2412 at Mode 1. At least some of the electromagnetic waves may propagate along the first branch to be output at the first output port 2414 at Mode 2. The rest of the electromagnetic waves may propagate along the second branch to be output at the second output port 2416 at Mode 3.

Three different cases are considered. In a first case, Mode 1 may be LSM₀₁. That is, the LSM₀₁ mode may be injected at the input port 2412. As the non-radiative dielectric waveguide does not include any slots over the bent dielectric strips 2404, 2406, mode conversion will occur between the LSM₀₁ mode and the LSE₁₁ mode over the first and second bent dielectric strips 2404, 2406. Therefore, Mode 2 and Mode 3 will be the LSE₁₁ mode. That is, the LSE₁₁ mode will be output at the first and second output ports 2414, 2416.

In a second case, one set of slots may be cut (e.g, etched) into one of the parallel conductive plates 2418. That is, rather than including a set of slots for each bend, a set of slots is only included for one bend. In this example, the set of slots is cut into one of the parallel conductive plates over the second bent dielectric strip 2406. Mode 1 may be LSM₀₁. That is, the LSM₀₁ mode may be injected at the input port 2412. As the non-radiative dielectric waveguide does not include any slots over the first bent dielectric strip 2404, mode conversion will occur between the LSM₀₁ mode and the LSE₁₁ mode over the first bent dielectric strip 2404. As the non-radiative dielectric waveguide includes slots over the second bent dielectric strip 2406, mode conversion will not occur between the LSM₀₁ mode and the LSE₁₁ mode over the second bent dielectric strips 2406. Therefore, Mode 2 will be the LSE₁₁ mode and Mode 3 will be the LSM₀₁ mode. That is, the LSE₁₁ mode will be output at the first output port 2414 and the LSM₀₁ mode will be output at the second output port 2416.

In a third case, sets of slots may be cut (e.g, etched) into one of the parallel conductive plates 2418 over the first and second bent dielectric strips 2404, 2406. That is, a set of slots may be included for each bend. In this example, each set of slots includes four slots. In other examples, more or fewer slots may be used. In this case, the slots over the first and second bent dielectric strips 2404, 2406 stop the mode conversion between the LSM₀₁ mode and the LSE₁₁ mode over the two bends. Therefore, when LSM₀₁ is injected into the input port 2412 (e.g. Mode 1 is LSM₀₁), Mode 2 and Mode 3 will be the LSM₀₁ mode. That is, the LSM₀₁ mode will be output at the first and second output ports 2414, 2416. This corresponds to the scenario described above in respect of FIG. 23.

In general, one or more of the plates of any of the non-radiative dielectric waveguides described herein, including those that form part of a waveguide assembly, such as the waveguide assembly 910 or the waveguide assembly 2300 may include a set of slots over a bend in a dielectric strip. In some examples, each bend may be provided with a respective set of slots. The set of slots may be cut into the respective plate using any suitable means such as etching. Each slot may extend over at least some of a width of the dielectric strip. In some examples, some or all of the slots may extend over the entire width of the dielectric strip. The set of slots may alternatively be referred to as a slot array. The set of slots may include one or more slots or, in some embodiments, a plurality of slots. A non-radiative dielectric waveguide including one or more slots may be referred to as a slot line non-radiative dielectric waveguide.

In the waveguide assembly 2300 and the non-radiative dielectric waveguide 2400, a single pair of plates covers the bent dielectric strips. In other embodiments, each bent dielectric strip may be covered by a respective pair of plates e.g. two separate pairs of plates may be used in the waveguide assembly 2300. In general, one or more bends in a waveguide assembly may be covered (e.g. sandwiched between) one or more pairs of parallel conductive plates.

Thus, a waveguide assembly may comprise a non-radiative dielectric waveguide at a bend in a junction of the waveguide assembly and a dielectric waveguide elsewhere. Although the waveguide assembly 2300 and the non-radiative dielectric waveguide 2400 are both dividers, it will be appreciated that similar features may apply to other types of junctions, such as combiners.

### An Example System

In a further aspect of the disclosure, an example system is provided. The system includes a waveguide assembly, a first component and a second component. The waveguide assembly may be any of the waveguide assemblies 800, 820, 2300, 2400, for example. The waveguide assembly connects the first component to the second component. The waveguide assembly may thus be for guiding an electromagnetic wave (a radio wave, a microwave, a millimeter-wave, a THz wave, an optical wave etc.) from the first component to the second component or vice-versa. Each of the first and second component may comprise any suitable component such as: an antenna, a low noise amplifier (LNA), a filter, a mixer, a power amplifier, a modulator etc. In an example, the system may comprise a transmitter, and the first and second components may be components of the transmitter (e.g. an antenna, a power amplifier, a filter, a mixer, a modulator, etc.). The transmitter may be any of the transmitters 201, 252, 272, for example. In another example, the system may comprise a receiver, and the first and second components may be components of the receiver (e.g. an antenna, an LNA, a filter, a mixer etc.). The receiver may be any of the receivers 203, 254, 274, for example. In yet another example, the system may comprise a transceiver, and the first and second components may be components of the transceiver (e.g. a combination of the components of the transmitter and/or receiver described above).

### An Example Method

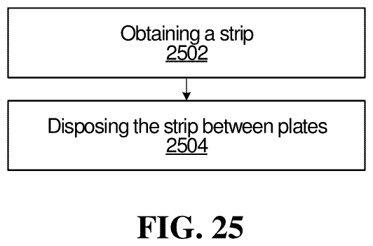

FIG. 25 is a flowchart of a method 2500 of manufacturing a waveguide assembly according to an embodiment of the disclosure.

The waveguide assembly may be any of the waveguide assemblies 800, 920, 2300, 2400, for example.

The method involves, in step 2502, obtaining a strip (e.g. length, slab, rod or sheet), of dielectric material. The dielectric material may be any suitable dielectric material, such as a lossless dielectric material. The dielectric strip may be formed from one or more of: alumina (e.g. with a dielectric constant of 9.8 or another value), a ceramic, silicon (e.g. HR-Si), sapphire. The dielectric strip may form a dielectric core. Obtaining the strip may involve forming the dielectric strip (e.g. drilling such as laser drilling to form the dielectric strip, deep reactive ion etching, DRIE, to form the dielectric strip, reactive ion etching, RIE, to form the dielectric strip, three-dimensional, 3D, printing the dielectric strip etc.). Obtaining the strip may involve cutting the dielectric strip from a larger dielectric rod. Obtaining the strip may involve receiving the strip of dielectric material.

The strip includes a bent section of the dielectric material. The bent section may be any of the bent dielectric strips 922, 2304, 2306, 2404, 2406, for example. The bent section includes at least one bend. The bend may be the bend 932, for example. Obtaining the strip may involve bending a section (e.g. a straight or straighter section) of the dielectric material to form the bend.

The method may also involve obtaining a pair of parallel conductive plates. Each of the conductive plates may include a sheet of conductive material (e.g. a sheet of a conductor). The plates may be planar (e.g. substantially flat). The plates may have substantially the same shape as one another. One or more of the conductive plates may be formed from metal, such as copper, gold or aluminium. The conductive plates may, for example, comprise metal plates or metallic plates. The conductive plates may form part of a conductive, metal or metallic housing. The conductive plates may comprise metal bridges, conductive bridges or metallic bridges. In some embodiments, one or more of the conductive plates may be formed from a superconducting material. The pair of parallel conductive plates may comprise the first and second conductive plates 928, 930, the pair of conductive plates 2318 or the pair of conductive plates 2418, for example.

Obtaining the pair of parallel conductive plates may involve forming (e.g. fabricating) the parallel conductive plates. For example, obtaining the pair of parallel conductive plates may forming the parallel conductive plates using micromachining. Alternatively, obtaining the pair of parallel conductive plates may involve receiving the conductive plates.

The method also involves, in step 2504, disposing the bent section of the strip between the pair of parallel conductive plates. Step 2504 may involve inserting the bent section between the plates. Step 2504 may involve applying each of the conductive plates to an opposing side of the bent section. Step 2504 may involve placing the bent section of dielectric material on one of the plates and then covering the bent section with the other of the plates. Any suitable method may be used to dispose the bent section between the pair of parallel conductive plates.

The bent section of the strip is disposed between the pair of parallel plates to cover two opposing sides of the bent section by the pair of parallel conductive plates. This forms a non-radiative dielectric waveguide. A remaining section of the strip of dielectric material is left exposed to form another waveguide connected to the non-radiative dielectric waveguide. This results in a waveguide assembly including a non-radiative dielectric waveguide with at least one bend connected to dielectric waveguide. The waveguide assembly may be used in the system described above, for example.

Disposing the bent section of the dielectric material between a pair of conductive parallel plates to form the non-radiative dielectric waveguide may be simpler and cheaper than existing approaches for metallizing waveguides. Moreover, this method 2500 can easily be applied to existing dielectric waveguides, which allows for retrofitting the waveguide assemblies of the present disclosure.

### CLOSING REMARKS

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

What is claimed is:

1. A waveguide assembly, comprising:
a first non-radiative dielectric waveguide comprising a first pair of parallel conductive plates and a first bent dielectric strip disposed between the first pair of parallel conductive plates, the first bent dielectric strip comprising a first bend; and
a first dielectric waveguide comprising a first exposed dielectric strip,
wherein the first non-radiative dielectric waveguide is connected to an end of the first dielectric waveguide to form a first transmission path for an electromagnetic wave through the first dielectric waveguide and the first non-radiative dielectric waveguide.

2. The waveguide assembly of claim 1, wherein the first exposed dielectric strip is straight.

3. The waveguide assembly of claim 1, wherein the first exposed dielectric strip further comprises a second bend having a larger radius than the first bend.

4. The waveguide assembly of claim 1, wherein the first bent dielectric strip and the first exposed dielectric strip are integrally formed.

5. The waveguide assembly of claim 1, further comprising:
a second dielectric waveguide comprising a second exposed dielectric strip, wherein the second dielectric waveguide is connected to the first non-radiative dielectric waveguide such that the first non-radiative dielectric waveguide is between the first dielectric waveguide and the second dielectric waveguide.

6. The waveguide assembly of claim 5, wherein the second exposed dielectric strip is straight.

7. The waveguide assembly of claim 6, wherein the second exposed dielectric strip has a third bend having a larger radius than the first bend.

8. The waveguide assembly of claim 5, wherein the second exposed dielectric strip is integrally formed with the first bent dielectric strip.

9. The waveguide assembly of claim 1, wherein the waveguide assembly is configured to receive a Terahertz wave for propagation along the first transmission path.

10. The waveguide assembly of claim 1, wherein the first non-radiative dielectric waveguide being connected to the end of the first dielectric waveguide forms a first branch of the waveguide assembly, the waveguide assembly further comprising:
a second non-radiative dielectric waveguide comprising a second pair of parallel conductive plates and a second bent dielectric strip disposed between the second pair of parallel conductive plates,
wherein the second non-radiative dielectric waveguide is connected to the end of the first dielectric waveguide to form a second branch of the waveguide assembly, the second branch of the waveguide assembly forming a second transmission path through the first dielectric waveguide and the second non-radiative dielectric waveguide.

11. The waveguide assembly of claim 10, further comprising a waveguide divider.

12. The waveguide assembly of claim 10, further comprising a waveguide combiner.

13. The waveguide assembly of claim 10, wherein the first pair of parallel conductive plates and the second pair of parallel plates are the same.

14. The waveguide assembly of claim 10, wherein the first pair of parallel conductive plates is separate to the second pair of parallel plates.

15. The waveguide assembly of claim 10, wherein the waveguide assembly is configured to receive a Terahertz wave for propagation along the first transmission path or the second transmission path.

16. A method of manufacturing a waveguide assembly, the method comprising:
obtaining a strip of dielectric material, the strip comprising a bent section of the dielectric material; and
disposing the bent section of the strip between a pair of parallel conductive plates to cover two opposing sides of the bent section by the pair of parallel conductive plates to form a non-radiative dielectric waveguide, wherein a remaining section of the strip is left exposed to form another waveguide connected to the non-radiative dielectric waveguide.

17. The method of claim 16, wherein the remaining section of the strip that is comprised in the another waveguide is straight.

18. The method of claim 16, wherein the strip further comprises a second bend having a larger radius than the bent section.

19. The method of claim 16, further comprising:
connecting the non-radiative dielectric waveguide to a second dielectric waveguide comprising another exposed dielectric strip.

20. The method of claim 19, wherein the another exposed dielectric strip is straight.
